(19) United States
(12) Patent Application Publication
(10) Pub. No.: US 2012/0107719 A1
(43) Pub. Date: May 3, 2012

(54) ELECTRODE CATALYST FOR MEMBRANE ELECTRODE OF FUEL CELL AND ITS METHOD OF PREPARATION AND FUEL CELL MEMBRANE ELECTRODE

(75) Inventors: Shijun Liao, Guangdong (CN); Huaping Zhu, Guangdong (CN); Leimin Xu, Guangdong (CN); Huaneng Su, Guangdong (CN); Lijun Yang, Guangdong (CN); Yanni Wu, Guangdong (CN); Zhenxing Liang, Guangdong (CN)

(73) Assignee: SOUTH CHINA UNIVERSITY OF TECHNOLOGY, Guangdong (CN)

(21) Appl. No.: 13/379,693

(22) PCT Filed: Mar. 30, 2010
(86) PCT No.: PCT/CN2010/071413

§ 371 Date: Dec. 21, 2011

(30) Foreign Application Priority Data
Jul. 24, 2009 (CN) 200910041374.7

(51) Int. Cl. H01M 4/92; B05D 3/02; B05D 5/12; H01M 4/90; H01M 8/10

(52) U.S. Cl. 429/482; 429/532; 429/524; 427/115

(57) ABSTRACT

This invention discloses an electrocatalyst for membrane electrode assembly, and its preparation method, as well as a fuel cell membrane electrode assembly. An electrocatalyst for fuel cell application, it is featured that the electrocatalyst is prepared by supporting precious metal (10-60 wt %) on a composite carrier which is prepared by depositing water-containing substance (0.3-10 wt %) on carbon material; Using the catalyst invented by this invention as anode catalyst, an fuel cell membrane electrode assembly with excellent non-humidification performance can be prepared by normal procedures. No need to construct a water retention layer, no need to add water retention material in proton exchange membrane, it avoids the possible problems caused by adding water attention material into proton exchange membrane or inserting a water retention layer. The approach suggested by this invention is a simple and effective approach to realize non-humidification membrane electrode assembly.

### FIELD OF THE INVENTION

The present invention relates to a fuel cell, and more specifically, to an electrocatalyst which has the function of self-humidifying in the fuel cell and a MEA with excellent self-humidifying performance prepared by using this electrocatalyst.

### BACKGROUND OF THE INVENTION

In the proton exchange membrane fuel cell (PEMFC), the management of water has decisive influence on the PEMFC performance. During the operation of the PEMFC, the reaction gases often need to be humidified externally in order to guarantee sufficient water content in the proton exchange membrane and the electrode to obtain high proton conductivity and electrochemical performance. The humidification of the gases is often achieved by complicated auxiliary humidification equipment which adds the complexity of the PEMFC system as well as its cost. Furthermore, the external humidification requires consuming a lot of energy, which decreases the total output power of the fuel cell system. Actually, a large amount of water may be generated in the cathode during the operation of the proton exchange membrane fuel cell. As a result, some researchers hope that the generated water can be made use of so as to achieve a self-humidifying or a non-humidified membrane electrode assembly and the corresponding fuel cell system. As a matter of fact, it has been one of the hot subjects studied in the fuel cell field to develop a non-humidified/self-humidifying fuel cell membrane electrode assembly.

The current research on the non-humidified/self-humidifying fuel cell membrane electrode assembly mainly focuses on the following: 1) to develop a composite proton exchange membrane with water-containing function by means of adding a water-containing substance; 2) to obtain the proton exchange membrane with water-containing function by adding precious metal catalyst into the proton exchange membrane, the principle of which is to achieve the humidification of membrane by the chemical reaction between the hydrogen and the oxygen infiltrated into the membrane, from anode and cathode side, where the water is generated; 3) to achieve the non-humidified/self-humidification by inserting a water-containing layer between the catalyst layer and the proton exchange membrane; 4) to achieve the non-humidified/self-humidification of the electrode by adding water-containing substance into the catalyst layer. Unfortunately, these methods have not obtained the ideal non-humidified/self-humidifying results till now. Moreover, some researchers also hope to achieve the non-humidified or self-humidification by designing and changing the flow field of bipolar plate, but the effect is far away from what the high-performance fuel cell requires for the non-humidified membrane electrode assembly and fuel cells.

Watanabe, et al. (Watanabe M., Uchida H., Seki Y., et al. J. Electrochem. Soc., 1996, 143: 3847-3852.) highly disperse the Pt particles and the metal oxide into the Nafion solution and then rebuild them into membranes, wherein the function of the Pt particles is to catalyze the reaction between the H₂ and O₂ infiltrated into membrane to generate water, while the oxide is used to keep the generated water in the membrane. The cell test shows that this kind of composite membrane has high performance and good stability under normal pressure and at low humidity (the humidification temperature of H₂ is 20° C., and without the humidification for O₂). When the current density is 0.9 Acm⁻², the power density of the cell can reach 0.63 Wcm⁻². After that, Watanabe M and his collaborators (Watanabe M., Uchida H., Emori M. J. Phys. Chem. B, 1998, 102: 3129-3137, Watanabe M., Uchida H., Emori M. J. Electrochem. Soc., 1998, 145: 1137-1141, Uchida H., Mizuno Y., Watanabe M., et al. J. Electrochem. Soc., 2003, 150: A57-A62, Hagihara H., Uchida H., Watanabe M. Electrochim. Acta, 2006, 51: 3979-3985) have made intensive research and optimization based on this method. However, there exists trouble in the preparation and the non-humidified effect can not meet the requirements of a long-term stability.

CN. Pat. No. ZL 02103832.5 discloses a preparation method of a self-humidifying composite membrane used for a proton exchange membrane fuel cell, that is, the composite membrane is formed by compounding the proton exchange membrane and the coating layer with moisturizing function. The preparation method of the composite membrane according to this patent is as follows: 0.1-10 μm inorganic matter or its oxide and the organic matter which has the same components with the organic membrane and the organic solvent being mixed equably, and being made into a slurry, and then overlaying the surface of the organic membrane with them, the self-humidifying composite membrane being obtained after drying and solidification. This preparation has a complex process, and the over size of the inorganic substance or its oxide may influence the transfer of the proton, which may lower the performance of the membrane electrode assembly. Therefore, this method is not suitable for applying to large-scale application in proton exchange membrane fuel cell.

CN. Pat. No. ZL 02122635.0 discloses “a preparation method of a self-humidifying composite exchange membrane for the fuel cell”, wherein this patent application is achieved by the method below: heating and dissolving the Nafion membrane in the organic alcohol and water solvent with low boiling point till it becomes a Nafion resin solution, and then adding the Pt-included carried catalyst and organic solvent with high boiling point into the Nafion resin solution, dripping the solution on the surface of the organic porous membrane, heating the self-humidifying composite membrane and preserving it in a vacuum state. In this method, the introduction of catalyst into the membrane is likely to cause short circuit in the anode and cathode and reduce the performance of the cell, thus it is not suitable for practical application.

CN. Pat. No. ZL 03140527.4 discloses a “self-humidifying solid electrolyte composite membrane and its technique of preparation”, the preparation technique is as follows: dissolving the sulfonated resin into the anhydrous alcoholic solvent under 0.5-8 MPa at 200-650° C. to get solution A, crushing the crystalline hydrate into particles of 5-100 nm under 100-600 MPa, dissolving them into the anhydrous alcoholic solvent under 0.5-8 MPa at 110-300° C. to get solution B, mixing the two solutions equably under 0.5-8 MPa at 200-650° C., then cooling them to 150-580° C. and turn them into a membrane by the casting method, putting them in the inert environment at 80-550° C. after drying them at room temperature and then obtaining the resultant membrane after heat treatment. This preparation has a complex process, and the solid electrolyte composite membrane prepared has a low conductivity.

CN. Pat. No. ZL 200510018545.6 discloses a “preparation method of a non-humidified proton exchange membrane used for the fuel cell”. Firstly, the uniform polymer solution is formed by dissolving the aromatic heterocyclic polymer including acid side groups into the organic solution, and then add the oxide precursor and the colloidal formed by inorganic acid, obtain the uniform mixture solution by ultrasonic dispersion, and obtain the non-humidified proton exchange membrane by the secondary doping to the membrane. This method needs a secondary doping and has a complex preparation process. What's more, the applicant does not illustrate the cell performance for the preparation of non-humidified proton exchange membrane.

CN. Pat. No. ZL 200510018740.9 discloses a “preparation method of the proton exchange membrane fuel cell chip with water-containing function”. This method is achieved by the following steps: coating a catalyst layer on the surface of the transfer medium, and then overlaying the surface of catalyst layer with the electrodeless nano-particle layer with the water-containing function; at last, the fuel cell chip through the hot pressure of the two electrodes and proton exchange membranes with water-containing function is prepared. The water-containing layer prepared in this way will increase the resistance of the proton transfer for the membrane electrode assembly.

CN. Pat. No. ZL 200510067575.1 discloses “a self-humidifying membrane electrode assembly and its preparation method”. This method is achieved by getting the self-humidifying membrane electrode assembly by adding the hydrophilic substances into the anode catalyst layer, and adding the hydrophobic substances into the cathode catalyst layer. The hydrophilic and hydrophobic substances used in this patent may increase the resistance of electric charge transfer in catalyst layer.

A CN. Pat. No. ZL 200610015662.1 discloses “a self-humidifying proton exchange membrane fuel cell membrane electrode assembly”, which realizes the self-humidifying of the membrane electrode assembly by constructing a constant humidity layer composed of carbon powder, adhesives, hydrophilic fiber between the catalyst layer and the gas diffusion layer. The constant humidity layer of the self-humidifying membrane electrode assembly prepared in this way may affect the dispersion of the reaction gases.

CN. Pat. No. ZL 200610134078.8 discloses “a self-humidifying composite proton exchange membrane enhanced by a carbon nanotubes as well as its preparation method”. There are two solutions: one is to add the Pt/CNTs into the Nafion resin solution, and cast it into membrane after the uniform ultrasonic dispersion, and then spray the Nafion resin of certain thickness on the two sides of the membrane, and put it in the vacuum drying oven at 120-200° C. for 0.5-20 h, and cool it to the three-layer composite membrane; the second solution is to add the CNTs into the Nafion resin, and cast it into the CNTs membrane, then spray the Pt/SiO₂-included Nafion resin solution on the two sides of the membrane, and the three-layer composite membrane is obtained after being dried and cooled. The conductivity of the composite membrane prepared in this way is reduced because of the delamination. In addition, the addition of SiO₂ may lower the proton conductivity of the membrane.

So far, all of these methods can not afford ideal non-humidified/self-humidifying effects.

### SUMMARY OF THE INVENTION

The object of the present invention is to provide an electrocatalyst for the fuel cell membrane electrode assembly.

The object of the present invention is also to provide a preparation method of the electrocatalyst for the fuel cell membrane electrode assembly.

The object of the present invention is also to provide a self-humidifying/non-humidified fuel cell membrane electrode assembly, and make the fuel cell having excellent non-humidified/self-humidifying performance through achieving the function of self-humidifying/non-humidified of the membrane electrode assembly by using the above-mentioned electrocatalysts.

An electrocatalyst for a fuel cell membrane electrode assembly, characterized in that the said electrocatalyst is prepared by supporting precious metal on a composite carrier which is a carbon carrier deposited by water-containing substance; in the electrocatalyst, there is 0.3-10 wt % water-containing substance and 10-60 wt % precious metal.

Furthermore, said water-containing substance is selected from at least one of Silica, Titanium Dioxide, Cerium Dioxide, Zirconium Dioxide, Tungsten Trioxide and Molybdenum Trioxide.

Furthermore, said precious metal is Platinum.

A preparation method of an electrocatalyst for a fuel cell membrane electrode assembly, comprises the following steps:

(1) An organic precursor of the water-containing substance is dissolved in volatile organic solvent, then a pre-processed carbon carrier is added to the dissolved solution and stirred at room temperature to uniformly mix the organic precursor of the water-containing substance and carbon carrier, and then the mixture is placed in a vacuum drying oven at 40-70° C. to remove the volatile organic solvent by vacuumization, and to take it out and it is heated in inert atmosphere at 200-600° C. for 1-5 hours and cooled, to obtain the carbon carrier deposited by the water-containing substance, which is the composite carrier;

(2) the composite carrier prepared in Step (1) is took as the carrier, and an electrocatalyst is prepared by supporting the precious metal on a composite carrier; In the electrocatalyst, the content of the water-containing substance is 0.3-10 wt %, and the content of the precious metal is 10-60 wt %.

In Step (2), the electrocatalyst of the composite carrier supporting the precious metal can be prepared by organic colloidal method, impregnation method or solid-phase reduction, etc.

Said carbon carrier shall be the carbon materials with excellent conductivity such as XC-72R carbon black, activated carbon and so on. Said volatile organic solvent includes the organic matter with a low boiling point such as anhydrous ethanol, acetone, etc. The said water-containing substances include the hydrophilic oxide such as silica, titanium dioxide, cerium dioxide, zirconium dioxide, tungsten trioxide and molybdenum trioxide, or the complex of no less than two of these oxides. The organic precursors of said water-containing substances are the organic matter such as silicon and titanium, for example: tetraethyl orthosilicate and tetraethoxy titanium, etc.

A fuel cell membrane electrode assembly comprises a proton exchange membrane, a anode and a cathode, wherein the proton exchange membrane is sandwiched between two electrodes, characterized in that, said electrocatalyst is used as ananode catalyst.

Furthermore, the catalyst also can be used as cathode catalyst of the membrane electrode assembly.

The preparation of the non-humidified membrane: said electrocatalyst is anode catalyst, with the using of the commercial catalyst or said electrocatalyst as the cathode catalyst, the membrane electrode assembly with excellent performance in self-humidifying/self-moisturizing can be prepared with a catalyst coated membrane approach following the general procedures of electrode preparation.

Compared with the existing non-humidified technology of the fuel cell, the present invention has the following advantages:

(1) By the pretreatment of carbon support with specific materials, a fuel cell catalyst with excellent performance in self-humidifying/self-moisturizing can be obtained, using this catalyst directly and the normal procedures of electrode preparation, a membrane electrode assembly with excellent moisture retention can be obtained; there is no need to construct a water-containing layer, and there is no need to add water-containing substances into the proton exchange membrane, which avoids the problems like the increasing of the resistance of the cell which is caused by the adding the water-containing substances into the water-containing layer and the proton exchange membrane. Therefore, this shall be a simple and efficient method for the preparation of the non-humidified membrane electrode assembly, and it benefits the large-scale preparation of the non-humidifying membrane electrode assembly of the proton exchange membrane fuel cell.

(2) The non-humidified catalyst prepared according to the present invention does not need the particular equipment and instruments. It has a simple preparation process and can bring the large-scale preparation of the catalyst into effect;

(3) The membrane electrode assembly prepared according to the present invention has shown better performance in non-humidified than that of the former ones reported in the research results on the condition of using the hydrogen as the fuel and the air as the oxidant without humidifying both of them.

### BRIEF DESCRIPTION OF THE DRAWINGS

FIG. 1 is the performance curve of the membrane electrode assembly in the hydrogen-air fuel cell. This membrane electrode assembly is prepared by using the Pt/Si0₂/C catalyst containing 0.3 wt % Silica as the anode catalyst.

FIG. 2 is the performance curve of the membrane electrode assembly in the hydrogen-air fuel cell. This membrane electrode assembly is prepared by using the Pt/Si0₂/C catalyst containing 3 wt % Silica as the anode catalyst.

FIG. 3 is the performance curve of the membrane electrode assembly in the hydrogen-air fuel cell. This membrane electrode assembly is prepared by using the Pt/Si0₂/C catalyst containing 6 wt % Silica as the anode catalyst.

FIG. 4 is the performance curve of the membrane electrode assembly in the hydrogen-air fuel cell. This membrane electrode assembly is prepared by using the Pt/Si0₂/C catalyst containing 9 wt % silica as the anode catalyst.

FIG. 5 is a comparative curve in the hydrogen-air fuel cell. Between the performance of the membrane electrode assembly prepared by using the Pt/SiO₂/C containing 3 wt % silica as the catalyst and the membrane electrode assembly prepared by using the commercial Pt/C as the catalyst.

### DETAILED DESCRIPTION OF THE ILLUSTRATED EMBODIMENT(S)

The present invention is herein further described in detail and in combination with the drawings and the embodiments, but is not limited by them.

The embodiments of the present invention are listed as below: a composite carrier is prepared with the organic precursor of water-retention substances and the carbon carrier, and then the catalyst is prepared by supporting precious metals on the composite carrier with an organic colloidal method, the electrode membrane assembly is prepared by using the electrocatalyst related to the present invention as the anode catalyst and the commercial catalyst or the electrocatalyst related to the present invention as the cathode electrode, finally the fuel cell is fabricated by assembling the membrane electrode assembly with other components.

### Embodiment 1

(1) Preparation of the composite carrier: adding 0.0155 g of tetraethyl orthosilicate into 3 ml of ethyl alcohol, and then adding 1 g of XC-72R carbon black pretreated by oxidation and heat treatment, stirring them for 15 minutes till the tetraethyl orthosilicate and the carbon black disperse equably, and then vacuumized to remove the residual ethyl alcohol in the vacuum oven at 40° C., then heat treated in inert gas flow at 300° C. for 3 h, followed by cooling them, and the carbon composite carrier material containing silica is obtained; It can be denoted as SiO₂/XC-72R or SiO₂/C;

(2) Preparation of the electrocatalyst: the composite carrier prepared in step (1) is took as the carrier, adopting the electrocatalyst which has prepared the composite carrier with precious metal carried using the organic colloidal method mentioned in patent ZL 200510102382.X; including following steps: taking the mixture of acetone and glycol as the solvent, glycol as the reducing agent, chloroplatinic acid as the precursor of platinum and sodium citrate as the complexing agent, leaving them to react in autoclave for 8 h at 120° C., and the electrocatalyst can be obtained after neutralization, destroying colloid, washing and drying.

In the preparation of the electrocatalyst, the content of platinum is ca. 25 wt %, and the content of SiO2 is ca. 0.3 wt %.

Preparation of the non-humidified membrane electrode assembly: using the above prepared catalyst as both anode and cathode catalyst, a membrane electrode assembly is prepared with an catalyst coated membrane under illumination method (ZL 200610035275.4), the loadings of platinum in the anode and the cathode are 0.1 mg Pt/cm² and 0.2 mg Pt/cm² respectively; the specific steps are listed as follows: (A) fixing the proton exchange membrane treated by being oxidized by hydrogen peroxide and acidized by sulfuric acid solution on a framework mold; (B) putting the fixed mold of proton exchange membrane under the infrared lamp, spraying the catalyst slurry on the two sides of the proton exchange membrane equably with a spray gun to form the cathode and the anode; (C) in the catalyst slurry, the ratio of catalyst to dry Nafion is 2.5:1; isopropyl alcohol is used as solvent.

(4) Test of the membrane electrode assembly: The test of the performance of the membrane electrode assembly is performed in a Arbin FCTS fuel cell testing system produced by Arbin Company. Firstly, the membrane electrode assembly prepared in Step (3) is assembled into a small test cell, then the MEA is activated under humidification, all the humidifying temperatures of the hydrogen and the air and the cell temperature are same of 60° C., and then cooling the temperatures of both dew point humidifier of air and hydrogen to the room temperature, finally the performance of the MEA is performed at a non-humidification condition, the cell temperature is setup at 50° C., the current densities of different times at the voltage of 0.6V.

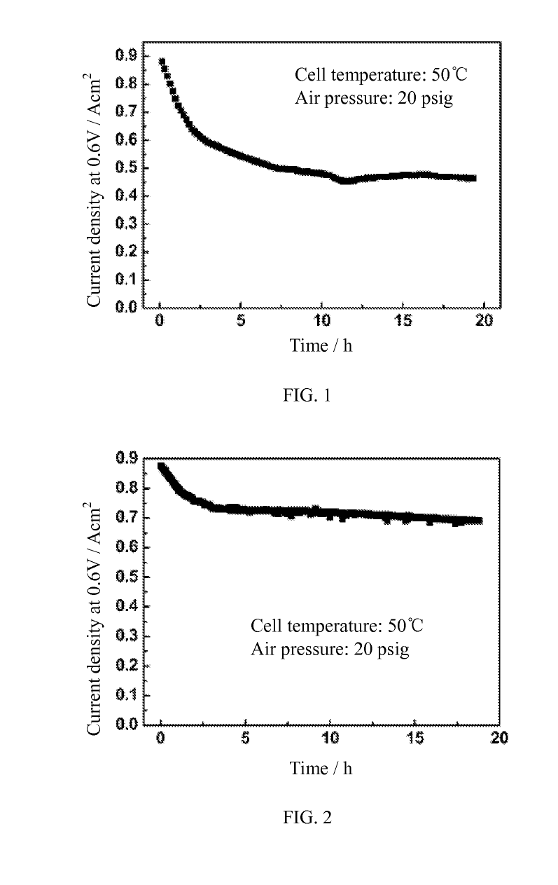

The result is shown in FIG. 1, within 5 hours, the current density decreased from 900 mA/cm² to 450 mA/cm², but then it remained substantially stable in the following 20 h, indicating the non-humidified effect in some extent.

### Embodiment 2

The other steps are the same as those of Embodiment 1 except the content of the tetraethyl orthosilicate added is 0.155 g and the content of the SiO₂ contained in the catalyst prepared is finally 3%.

The result shows that: the membrane electrode assembly prepared by using Pt/SiO₂/C containing 3% SiO₂ as the catalyst shows an excellent non-humidified effect, the current density has decreased only by 200 A/cm² (from 900 mA/cm² to 700 mA/cm²) within 3 h, and then remained substantially stable in the following 20 h (see FIG. 2).

### Comparative Embodiments

Except using the commercial Pt/C catalyst without silica (Johnson Matthey, Hispec4100, 40 wt % Pt) instead of the composite catalyst of embodiment 1, the other preparation steps and testing steps are as the same as step (3) and step (4) of embodiment 1.

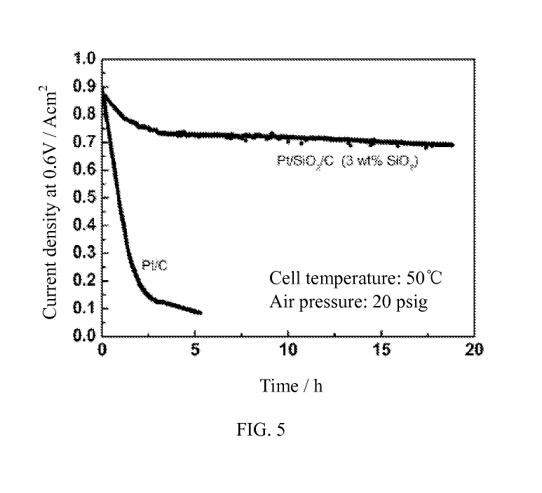

The result shows that: the membrane electrode assembly prepared by the catalyst without silica has no non-humidified capability, the current density has decreased from 900 mA/cm² to less than 100 mA/cm² within 3 h (see FIG. 5).

### Embodiment 3

Except increasing the amount of the tetraethyl orthosilicate and using the acetone instead of the absolute ethanol as the dispersion medium of tetraethyl orthosilicate, which makes the Pt/SiO₂/C catalyst prepared finally contain 6% SiO₂, the others are the same with embodiment 1.

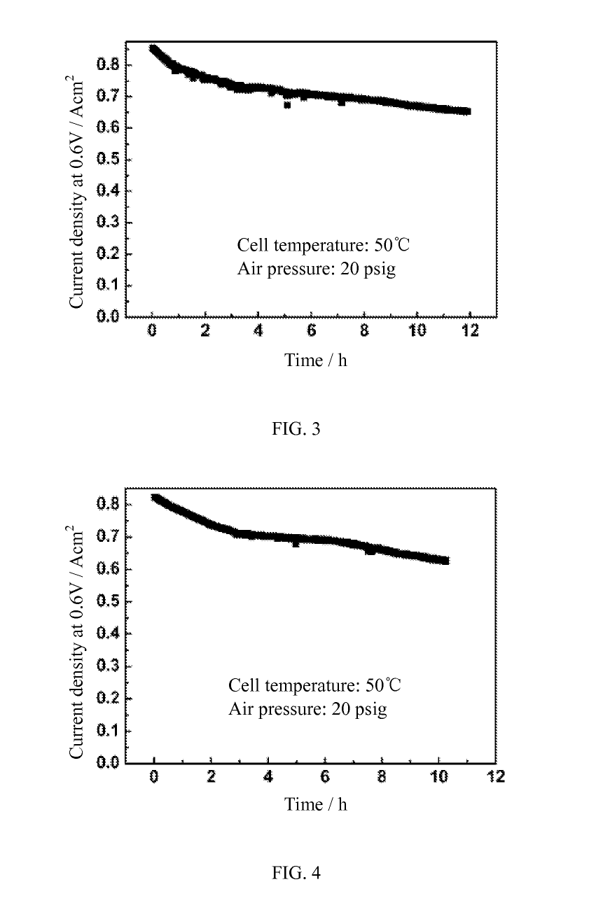

The results are shown in FIG. 3 and Table 1. The non-humidified effect is worse than the membrane electrode assembly prepared by the catalyst containing 3% silica.

### Embodiment 4

Except the content of tetraethyl orthosilicate used is 0.465 g and the content of SiO₂ contained in the catalyst Pt/SiO₂/C prepared finally is 9%, the temperature and the time of roasting the tetraethyl orthosilicate in the environment filled with insert gas after its dipping are respectively 600° C. and 1 h, the others are the same with embodiment 1.

The results are shown in FIG. 4 and Table. 1, the non-humidified effect is worse than that of the membrane electrode assembly prepared by the catalyst containing 3% silica, and is also worse than that of the membrane electrode assembly prepared by the catalyst containing 6% silica.

### Embodiment 5

(1) Preparation of the composite carrier: adding 0.0155 g of tetraethyl orthosilicate into 3 ml of ethyl alcohol, and then adding 1 g of XC-72R carbon black pretreated by oxidation and heat treatment, stirring them for 15 minutes till the tetraethyl orthosilicate and the carbon black disperse equably, and then vacuumized to remove the residual ethyl alcohol in the vacuum oven at 70° C., then heat treated in inert gas flow at 200° C. for 5 h, followed by cooling them, and the carbon composite carrier material containing silica is obtained; It can be denoted as SiO₂/XC-72R or SiO₂/C;

(2) Preparation of the electrocatalyst: the composite carrier prepared in step (1) is took as the carrier, adopting the electrocatalyst which has prepared the composite carrier with precious metal carried using the organic colloidal method mentioned in patent ZL 200510102382.X; including following steps: taking the mixture of acetone and glycol as the solvent, glycol as the reducing agent, chloroplatinic acid as the precursor of platinum and sodium citrate as the complexing agent, and the electrocatalyst can be obtained by reaction in autoclave.

In the electrocatalyst of the composite carrier supporting the precious metal mentioned in step (2), the content of platinum is 10 wt %, and the content of SiO₂ is 10%.

(3) Preparation of the non-humidified membrane electrode assembly: the same as embodiment 1.

(4) Test of the membrane electrode assembly: the same as embodiment 1, but the temperature of the cell is 60° C.

The result is shown in table 1. The current density has decreased from 870 mA/cm² to 430 mA/cm² within 5 h, and decreased to 310 mA/cm² within 20 h, which shows some non-humidified effect.

### Embodiment 6

(1) Preparation of the composite carrier: adding 0.0155 g of tetraethyl orthosilicate into 3 ml of ethyl alcohol, and then adding 1 g of XC-72R carbon black pretreated by oxidation and heat treatment, stirring them for 15 minutes till the tetraethyl orthosilicate and the carbon black disperse equably, and then vacuumized to remove the residual ethyl alcohol in the vacuum oven at 40° C., then heat treated in inert gas flow at 400° C. for 3 h, followed by cooling them, and the carbon composite carrier material containing silica is obtained; It can be denoted as SiO₂/XC-72R or SiO₂/C;

(2) Preparation of the electrocatalyst: the composite carrier prepared in step (1) is took as the carrier, adopting the electrocatalyst which has prepared the composite carrier with precious metal carried using the organic colloidal method mentioned in patent ZL 200510102382.X; including following steps: taking the mixture of acetone and glycol as the solvent, glycol as the reducing agent, chloroplatinic acid as the precursor of platinum and sodium citrate as the complexing agent, and the electrocatalyst can be obtained by reaction in autoclave. [0073] In the electrocatalyst of the composite carrier supporting the precious metal mentioned in step (2), there is 60 wt % of the platinum and 3 wt % SiO₂.

(3) Preparation of the non-humidified membrane electrode assembly: the same as embodiment 1.

(4) Test of the membrane electrode assembly: the same as Embodiment 5

The result is shown in Table 1. The current density has decreased from 920 mA/cm² to 730 mA/cm² within 5 h, and decreased to 705 mA/cm² within 20 h; this shows a good non-humidified effect.

### Embodiment 7

Excepting using the tetraethyl orthosilicate and N-butyl titanate instead of the tetraethyl orthosilicate, the composition of the catalyst is Pt/SiTiOx/C, where Si:Ti=1:1, the content of titanium silicon oxide is 3.5%, and the content of platinum is 25 wt %, the others are the same as embodiment 1.

As it is shown in table 1, the current density has decreased from 900 mA/cm² to 750 mA/cm² within 5 h, and then remained substantially stable within 20 h, which shows a good non-humidified effect.

### Embodiment 8

Excepting using the N-butyl zirconate instead of the for the N-butyl titanate, the composition of the catalyst is Pt/SiZrOx/C, where Si:Zr=1:1, the content of zirconium silicon oxide is 3.5%, the others are the same as embodiment 7.

As it is shown in Table 1, the current density has decreased from 920 mA/cm² to 730 mA/cm² within 5 h, and then remained substantially stable within 20 h, which shows a good non-humidified effect.

### Embodiment 9

Excepting using the organic molybdate ester instead of the N-butyl titanate, the composition of the catalyst is Pt/SiMoOx/C, where Si:Mo=1:1, the content of the molybdenum silicon oxide is 3.5%, the others are the same with Embodiment 7.

As it is shown in table 1, the current density has decreased from 930 mA/cm² to 760 mA/cm² within 5 h, and then remained substantially stable within 20 h, which shows a good non-humidified effect.

### Embodiment 10

Excepting using the organic tungstate ester instead of the N-butyl titanate, the composition of the catalyst is Pt/SiWOx/C, where Si:W=1:1, the content of the molybdenum silicon oxide is 3.5%, the others are the same as embodiment 7.

As it is shown in table 1, the current density has decreased from 920 mA/cm² to 730 mA/cm² within 5 h, and then remained substantially stable within 20 h, which shows a good non-humidified effect.

### Embodiment 11

Excepting for that the cerium nitrate is dissolved in the ethanol directly rather than in N-butyl titanate, the composition of the catalyst is Pt/SiCeOx/C, where Si:Ce=1:1, the content of the cerium silicon oxide is 3.5%, the others are the same as embodiment 7.

As shown in table 1, the current density has decreased from 890 mA/cm² to 740 mA/cm² within 5 h, and then remained substantially stable within 20 h, which shows a good non-humidified effect.

### Embodiment 12

(1) Preparation of the composite carrier: In addition that the amount of the tetraethyl orthosilicate is 0.155 g, the others are the same with Embodiment 1.

(2) Preparation of the electrocatalyst: the composite carrier prepared in step (1) is took as the carrier, and preparing the electrocatalyst of composite carrier supporting the precious metal through the solid-phase reduction technology; the specific steps are as following: a certain amount of chloroplatinic acid is dissolved into the mixture solvent of ethanol and water, and the complexing agent of sodium citrate is added, and the composite carrier prepared in step (1) is also added, and it is placed in a vacuum drying oven at 70° C. after 15 minutes of ultrasound treatment; the sodium formate solution is sprayed while it is stirred, and it is dried in a vacuum drying oven at 40° C., and the platinum is reduced by raising the temperature to 100° C.; then the electrode is obtained;

In the preparation of the electrocatalyst prepared, the content of platinum is 25 wt % and the content of SiO₂ is 3 wt %.

(3) Preparation of the non-humidified membrane electrode assembly: the same as embodiment 1.

(4) Test of the membrane electrode assembly: the same with Embodiment 1.

The result is shown in table 1. The current density has decreased from 880 mA/cm² to 630 mA/cm² within 5 h, and decreased to 603 mA/cm² within 20 h, which shows a certain non-humidified effect. But the overall performance is not as good as that of other similar catalysts prepared using the organic sol-gel method.

### Embodiment 13

(1) Preparation of the composite carrier: In addition that the content of the tetraethyl orthosilicate is 0.155 g, the others are the same as embodiment 1.

(2) Preparation of the electrocatalyst: the composite carrier prepared in Step (1) is took as the carrier, the electrocatalyst of composite carrier supporting the precious metal is obtained through impregnation method; the specific steps are: a certain amount of chloroplatinic acid is dissolved into the mixture solvent of ethanol and water, the complexing agent of sodium citrate is added, the composite carrier prepared in Step (1) is also added, and it is placed in a vacuum drying oven at 70° C. after 15 minutes of ultrasound treatment; and the dried sample is placed in a tube-shaped electric stove, reduced for 3 h at 200° C.; the electrode is obtained;

In the preparation of the electrocatalyst, the content of platinum is 25 wt % and the content of SiO₂ is 3 wt %.

(3) Preparation of the non-humidified membrane electrode assembly: the same as embodiment 1.

(4) Test of the membrane electrode assembly: the same as embodiment 1.

The result is shown in Table 1. The current density has decreased from 910 mA/cm² to 670 mA/cm² within 5 h, and decreased to 620 mA/cm² within 20 h, which shows a certain non-humidified effect. But the overall performance is not as good as that of other similar catalysts prepared in the way of organic sol-gel method.

TABLE 1
Comparison of the test results of all the embodiments

| | | | | Current |
|---|---|---|---|---|
| | | Original | Current | Density |
| | | Current | Density After | After |
| | | Density | 5 h | 20 h |
| Embodiments | Catalyst | mA/cm² | mA/cm² | mA/cm² |
| 1 | Pt/SiO₂/C | 910 | 550 | 480 |
| | (0.3% SiO₂) | | | |
| Comparative | Pt/C (JM40%) | 900 | 88 | — |
| 2 | Pt/SiO₂/C | 910 | 740 | 710 |
| | (3% SiO₂) | | | |
| 3 | Pt/SiO₂/C | 910 | 670 | 610 |
| | (6% SiO₂) | | | (10 h) |
| 4 | Pt/SiO₂/C | 920 | 730 | 710 |
| | (9% SiO₂) | | | |
| 5 | Pt/SiO₂/C | 870 | 430 | 310 |
| 6 | Pt/SiO₂/C | 910 | 730 | 705 |
| 7 | Pt/SiTiOₓ/C | 900 | 750 | 725 |
| 8 | Pt/SiZrOₓ/C | 920 | 730 | 710 |
| 9 | Pt/SiMoOₓ/C | 930 | 760 | 730 |
| 10 | Pt/SiWOₓ/C | 920 | 730 | 700 |
| 11 | Pt/SiCeOₓ/C | 890 | 740 | 710 |
| 12 | Pt/SiO₂/C | 880 | 630 | 603 |
| | (Solid-Phase | | | |
| | Reduction | | | |
| | Method) | | | |
| 13 | Pt/SiO₂/C | 910 | 670 | 630 |
| | (Impregnation | | | |
| | Method) | | | |

What is claimed is:

1. An electrocatalyst for membrane electrode assembly of fuel cell, characterized in that, said electrocatalyst is prepared by supporting precious metal on a composite carrier which is a carbon carrier deposited by water-containing substance; in the electrocatalyst, the content of the water-containing substance is in range of 0.3-10 wt %, and the content of precious metal is in range of 10-60 wt %.

2. The electrocatalyst according to claim 1, characterized in that the water-containing substance is selected from at least one of following materials, silica, titanium dioxide, cerium dioxide, zirconium dioxide, tungsten trioxide and molybdenum trioxide.

3. The electrocatalyst according to claim 1, characterized in that said precious metal is platinum.

4. A preparation method of an electrocatalyst for membrane electrode assembly of fuel cell, characterized in that it comprises following steps:
(1) An organic precursor of the water-containing substance is dissolved into a volatile organic solvent, then a pre-processed carbon carrier is added and stirred at room temperature to equably mix the organic precursor of the water-containing substance on the carbon carrier, and then it is placed in a vacuum drying oven at 40-70° C., the volatile organic solvent is removed by vacuumization, and it is took out and heated for 1-5 h in an environment filled with insert gases at 200-600° C., the carbon carrier deposited is obtained by the water-containing substance afterbeing cooled, which is the composite carrier;
(2) The composite carrier prepared in Step (1) is took as the carrier, and prepare the electrocatalyst with composite carrier supporting the precious metal;
In the electrocatalyst, the content of the water-containing substance is 0.3-10 wt %, and the content of the precious metal is 10-60 wt %.

5. The preparation method according to claim 4, characterized in that the step (2) adopts the organic sol-gel method, the impregnation method or the solid-phase reduction method to prepare the electrocatalyst with composite carrier carrying the precious metal.

6. The preparation method according to claim 4 or 5, characterized in that the said water-containing substance is selected from at least one of silica, titanium dioxide, cerium dioxide, zirconium cioxide, tungsten trioxide and molybdenum trioxide.

7. The preparation method according to claim 4, characterized in that said volatile organic solvent is ethanol or acetone.

8. A fuel cell membrane electrode assembly, comprises a proton exchange membrane, a anode and a cathode, and where the proton exchange membrane is between the two electrodes, characterized in that the electrocatalyst according to claim 1 is an anode catalyst.

9. The fuel cell membrane electrode assembly according to claim 8, characterized in that the electrocatalyst according to claim 1 is a cathode catalyst.
